(19) United States
(12) Patent Application Publication
(10) Pub. No.: US 2024/0081579 A1
(43) Pub. Date: Mar. 14, 2024

(54) AIR FRYER WITH RIB, DIVIDER DETECTION, AND DIVIDER EJECTION

(71) Applicant: Instant Brands Holdings Inc., Downers Grove, IL (US)

(72) Inventors: Gregory Klostermann, Downers Grove, IL (US); Brian Dengler, Downers Grove, IL (US)

(73) Assignee: Instant Brands Holdings Inc., Downers Grove, IL (US)

(21) Appl. No.: 18/454,996

(22) Filed: Aug. 24, 2023

Related U.S. Application Data
(60) Provisional application No. 63/405,255, filed on Sep. 9, 2022.

(51) Int. Cl. A47J 37/06

(52) U.S. Cl. CPC A47J 37/0641; A47J 37/0664

(57) ABSTRACT

An apparatus includes a housing, a container defining a chamber in which food to be air fried is disposed, and a divider removably disposed within the container. The divider may divide the chamber into a first cooking zone and a second cooking zone. A floor of the container may include a rib restricting air flow underneath a food placement element extending over the rib between the first cooking zone and the second cooking zone. An ejection button may be configured to eject the divider from a fully engaged position. A sensor may be configured to sense a presence or an absence of the divider in the container.

### RELATED APPLICATION

This application claims the benefit of U.S. Provisional Application No. 63/405,255, filed Sep. 9, 2022, the entirety of which is herein incorporated by reference.

### TECHNICAL FIELD

The present description relates generally to cooking products, and more specifically to an air fryer.

### BACKGROUND

Air fryers are cooking products that produce a crisp layer on food by circulating hot air. Some air fryers allow for adjusting a number of cooking zones between a single zone and multiple zones within a single housing. Ways to optimize operation, cooking, and usability of such air fryers may be desirable.

### BRIEF SUMMARY

The present description describes an apparatus configured to air fry food that includes at least one of: a rib integrated with a floor of a container, an ejection button configured to eject a divider from a fully coupled position within the container, or a sensor configured to detect a presence or an absence of the divider within the container. In some implementations, an apparatus comprises: a housing; a chamber within the housing in which food to be air fried is disposed; a food placement element comprising a surface on which the food is placed in the chamber; and a container in which the food placement element is disposed within the housing, wherein the container comprises a floor comprising a rib, and wherein the food placement element extends over the rib.

In some other implementations, an apparatus comprising: a housing; a container defining a chamber in which food to be air fried is disposed; a divider removably disposed within the container, the divider dividing the chamber into a first cooking zone and a second cooking zone; and a sensor configured to sense a presence or an absence of the divider within the chamber.

In some other implementations, an apparatus comprises: a housing; a container defining a chamber in which food to be air fried is disposed; a divider removably disposed within the container, the divider dividing the chamber into a first cooking zone and a second cooking zone; and an ejection button configured to eject the divider from a fully coupled position within the container.

Other implementations are possible, and features of each of the implementations can be used alone or together in combination. Accordingly, various embodiments will now be described with reference to the attached drawings.

### BRIEF DESCRIPTION OF THE DRAWINGS

FIG. 1 shows a perspective view of an air fryer with a container in a closed position.

FIG. 2 shows a perspective view of the air fryer with the container in an open position.

FIG. 3 shows a perspective view of the container and a food placement element in isolation.

FIG. 4 shows a perspective view of the food placement element in isolation.

FIG. 5 shows a perspective view of the container in isolation.

FIG. 6 shows a top view of the container in isolation.

FIG. 7 shows a cross-sectional side view of the container and food placement element in isolation.

FIG. 8 shows a perspective view of the container, food placement element, and a divider in isolation.

FIG. 9 shows a cross-sectional side view of the container, food placement element, and divider in isolation.

FIG. 10 shows a perspective view of an air fryer with a sensor configured to detect a presence or absence of a divider, and an ejection button configured to eject the divider from a fully coupled position.

FIG. 11 shows a partial side view of the air fryer of FIG. 10, illustrating an example configuration of the sensor coupled to an actuator arm.

FIG. 12 shows a cross-sectional side view of the air fryer of FIG. 10, illustrating an example configuration of the ejection button operatively coupled to a slide actuator and ejector tabs.

FIG. 13 shows a top view of the air fryer of FIG. 10 with the example ejection configuration of FIG. 12.

### DETAILED DESCRIPTION

The present description describes various embodiments of a product, appliance, apparatus, cooking product, cooking appliance, cooking apparatus, and related methods for air frying. For simplicity, such products, appliances, and apparatuses are referred to as an air fryer. As described in various detail below, the embodiments of the air fryer described herein include: a rib on a floor of an internal container or basket below a tray or food placement element that restricts air flow below the tray, a sensor configured to detect presence or absence of a divider that divides an internal chamber into multiple cooking zones, and/or an ejection button configured to eject the divider from a fully coupled position within the basket.

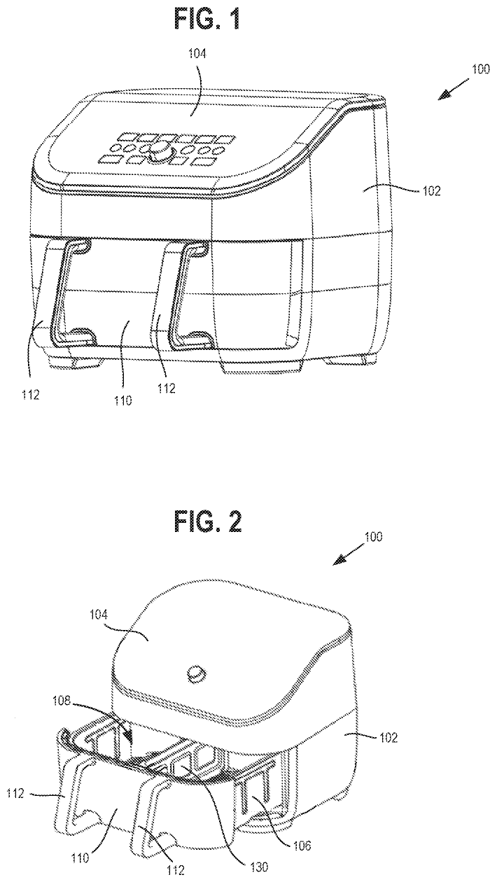

FIG. 1 shows a perspective view of an air fryer 100 configured to air fry food. The air fryer 100 includes a housing 102 within which food is cooked. Additionally, the air fryer 100 may include a control panel 104 integrated with, or that is part of, the housing 102 and that is configured receive user inputs that allows a user to control operation of the air fryer 100. Example inputs include, but not limited to, at least one of: a start input to cause the air fryer 100 to start or begin cooking (e.g., air frying); a temperature input to set and/or adjust a cooking temperature, a time input to set or adjust a cooking time; a zone input to set a number of cooking zones or areas (e.g., one (a single) cooking zone or two (dual) cooking zones), a synchronize cooking input to cook in multiple cooking zones at the same time according to the same cooking settings, or a synchronization finish input to cook in multiple cooking zones at the same time according to different or individual cooking settings for the multiple cooking zones.

Also, for at least some embodiments, the air fryer 100 may be configured to operate in multiple cooking modes, one of which is an air fryer mode to air fry food. Other example cooking modes may include, but not limited to, at least one of: roasting, baking, broiling, dehydration, or reheating. Correspondingly, the control panel 102 may be configured to receive an input that allows a user to set a cooking mode of the air fryer 100. In this context, the use of the term “air fryer” herein refers to a cooking apparatus or appliance configured to at least air fry food, and is not intended to limit the type of cooking to only air frying.

Also, the control panel 104 may include a display configured to display any of various information related to operation of the air fryer 100, including but not limited to information indicating a user input, such as a set cooking temperature, a set time duration for a cooking session, a time remaining during a cooking session, a selected cooking mode, a number of cooking zones set by a zone input, or whether the user selected a synchronization cooking input or synchronization finish input.

Additionally, although not shown in FIG. 1, within the housing 102, the air fryer 100 may include components that enable the air fryer 100 to cook food, such as a heating element and a fan. For the configuration of the air fryer 100 in FIG. 1, at least some of such components are positioned beneath or under the control panel 104 and above the food when being cooked within the housing 102.

Also, as used herein, terms “above”, “below”, “top”, “bottom”, “under” and “over”, “beneath”, “upper”, “lower”, “upward”, “downward”, and other similar terms are used to describe components and relative positioning of the components of the air fryer 100 when the air fryer 100 is positioned in its intended position for operation on a base having a flat surface, such as a countertop or a tabletop, as non-limiting examples. The term “top” is used to refer to the component or components of the air fryer 100 that are farthest from the flat surface of the base, and the term “bottom” is used to refer to the component or components of the air fryer 100 that are closest to and/or in contact with the flat surface of the base when the air fryer 100 is in its intended position. Correspondingly, terms like “above”, “over”, “upper” are used to refer to positioning or disposition of components closer to the “top” and farther from the “bottom” (or farther from the flat surface of the base), and terms like “below”, “under”, and “lower” are used to refer to positioning or disposition of components closer to the “bottom” and farther from the “top” (or closer to the flat surface of the base).

Referring also to FIG. 2, the air fryer 100 may include a basket or container 106 defining a chamber 108 in which food to be cooked by the air fryer 100 is placed or disposed. The container 106 may be movable relative to the housing 102 between open and closed positions. FIG. 1 shows the container 106 in the closed position, and FIG. 2 shows the container in the open position. In the closed position (FIG. 1), the container 106 may be housed or disposed within the housing 102. The closed position is the position that the container 106 is in when the air fryer 100 is operating (i.e., cooking in the container 106). In open position (FIG. 2), the container 106 is at least partially outside of the housing 102. In addition, in the open position, the chamber 108 is accessible to a user, such that the user can place food in the chamber 108 or remove food from the chamber 108. For at least some embodiments, the container 106 is slidably engaged with the housing 102 in order to move between the open and closed positions.

Additionally, as shown in FIGS. 1 and 2, the container 106 may be coupled to a portion 110 of the housing 102. The housing portion 110 may include, or be attached to, at least one handle 112 that a user can grasp to move, such as by sliding, the container 106 between the open and closed positions.

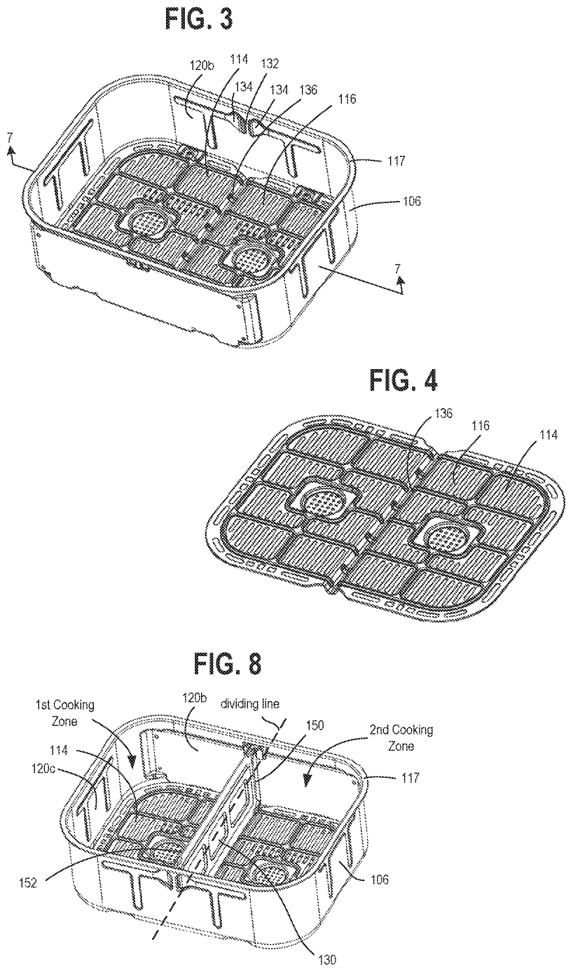

Referring to FIG. 3, the air fryer 100 may further include a food placement element (also called a cooking tray or tray) 114 on which food is placed in the chamber 108. FIG. 3 shows the container 106 and the food placement element 114 in isolation. As shown in FIG. 3, the food placement element 114 is positioned or disposed in the container 106. In particular embodiments, the food placement element 114 is removably disposed within the container 106. In this way, the food placement element 114 may be removed and separated from the container 106.

Additionally, the food placement element 114 may have an intended or desired position within the container 106. FIG. 3 shows the food placement element 114 in its intended position within the container 106. In its intended position, a surface 116 of the food placement element 114 on which food is to be placed faces in an upward direction, i.e., a direction away from a flat surface of a base on which the air fryer 100 is placed for operation.

FIG. 4 shows the food placement element 114 in isolation. As shown in FIG. 4, in some embodiments, the food placement element 114 is a single structure. In other embodiments, the food placement element includes multiple structures that, in combination within the container 106, form a substantially single, planar surface on which food may be placed. Also, the food placement element 114 may be sized so that only one food placement element 114, in its intended position, may be disposed in the container 106 at a single time. In various embodiments, a surface area of the food placement element 114, such as defined by an outer perimeter of the food placement element 114, may be at least 90 percent of an area of an opening of the chamber 108, such as defined by an upper lip or edge 117 of the container 106.

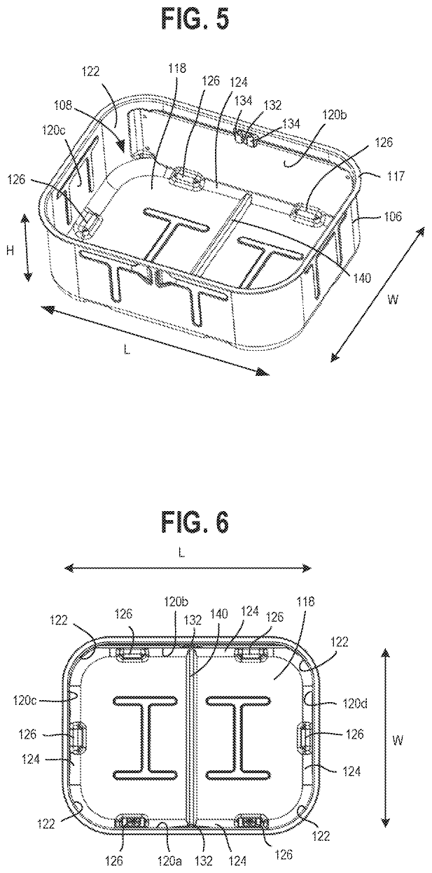

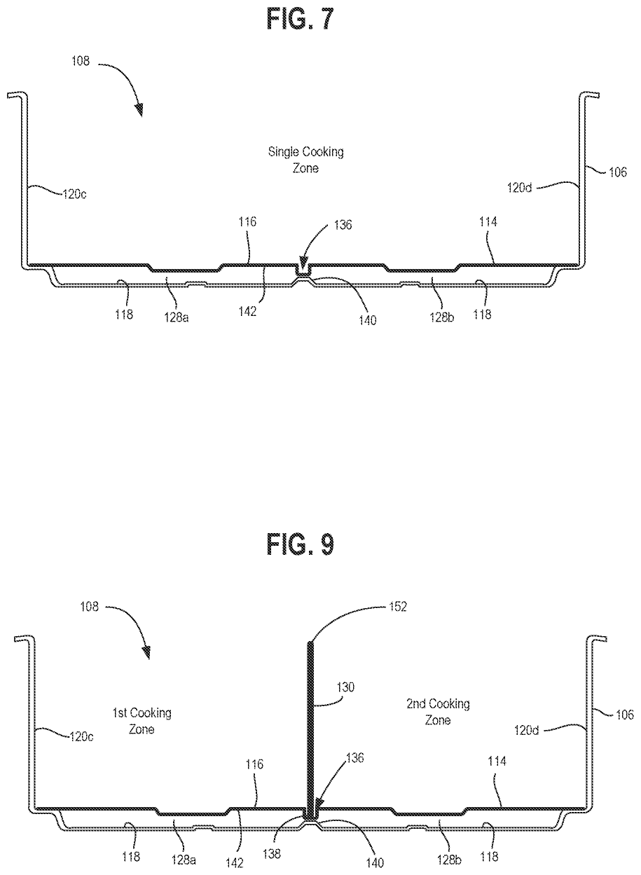

FIG. 5 shows a perspective view of the container 106 in isolation. FIG. 6 shows a top view of the container 106 in isolation. FIG. 7 shows a cross-sectional side view of the container 106 and the food placement element 114, in isolation, taken along line 7-7 in FIG. 3. As shown in each of FIGS. 6, 7, and 8, the container 106 may include an inner surface defining, at least in part, the chamber 108. The inner surface may include a plurality of inner surface portions, including a floor 118 and a plurality of side surfaces 120. The floor 118 may be a lowest inner surface of the container 106. In addition, the floor 118 may extend generally parallel with the food placement element 114. The side surfaces 120 may be oriented substantially perpendicular to the floor 118.

In addition, for each least some embodiments, such as shown in FIGS. 3, 5, and 6, the floor 118 may have, and the side surfaces 120 may be positioned relative to each other to form, a rectangular shape. For such embodiments, the side surfaces 120 may include two pairs. For each pair, the side surfaces oppose each other across the floor 118 and face each other. For example, as best shown in FIG. 6, a first pair of sides surfaces 120a, 120b oppose and face each other, and a second pair of side surfaces 120c, 120d oppose and face each other. Also, a surface of a given pair is adjacent to the side surfaces of the other pair. For example, the side surfaces 120a, 120b of the first pair are each adjacent to each of the side surfaces 120c, 120d of the second pair. For at least some of these embodiments, such as shown in FIGS. 3, 5, and 6, the inner surface may include curved corner surfaces 122 that connect adjacent side surfaces 120. Additionally, the inner surface may include a curved transition surface 124 that transitions the inner surface between the floor 118 and the side surfaces 120. In various embodiments, the curved transition surface 124 may be considered part of the side walls 120. Other embodiments may not include the curved corner surfaces 122 such that adjacent side surfaces directly meet, and/or may not include the curved transition surface 124 such that the floor 118 and the side surfaces 120 directly meet. In addition or alternatively, in various of other embodiments, shapes other than a rectangular shape, such as circular, triangular, or polygonal with a number of side surfaces greater than four (e.g., pentagonal, hexagonal, octagonal, etc.) may be possible.

Additionally, as shown in FIGS. 5, 6, and 7, the inner surface may include a plurality of shoulders 126, such as integrated with the curved transition surface 124, on which the food placement element 114 rests or is disposed when in its intended position in the container 106. The shoulder 126 may position the food placement element 114 above the floor 118, such that a space or volume 128 is between the floor 118 and the food placement element 114. The space 128 may allow air flow underneath the food placement element 114 for optimal cooking (e.g., air frying).

Referring to FIGS. 2-7, and further to FIGS. 8 and 9, the air fryer 100 may include a divider 130 that is removably couplable and/or engageable with the container 106 and the food placement element 114. By being removably couplable and/or engageable, the divider 130 may be coupled to, attached to, in contact with, and/or engaged with the container 106 and the food placement element 114, and may be uncoupled with, removed, detached, and/or separated from the container 106 and the food placement element 114. FIGS. 3, 7 show the divider 130 absent from the air fryer 100 (e.g., uncoupled from the container 106 and the food placement element 114). FIGS. 2, 8 and 9 show the divider 130 present in the air fryer 100 (e.g., coupled to the container 106 and the food placement element 114).

In addition, as shown in FIGS. 2, 8, and 9, when coupled to and/or engaged with the container 106 and the food placement element 114, the divider 130 is disposed in the container 106 (e.g., within the chamber 108). Additionally, the divider 130 is generally a planar structure. When coupled to the container 106 and the food placement element 114, the divider 130 is in substantially perpendicular to the food placement element 114 (e.g., to surface 116 of the food placement element) and to the floor 118.

Also, for at least some embodiments, the divider 130 may be slidably engageable with the inner surface of the container 106. Referring to FIGS. 3, 4, and 9, for at least some embodiments, the inner surface of the container 106, such as the side walls 120a, 120b, may includes tracks or grooves 132 that guide the slidable engagement between the divider 130 and the side walls 120a, 120b as the divider 130 slides into and out of the container 106. Portions 134 of the inner surface defining the tracks 132 may also keep the divider 130 stable or secure in its perpendicular position when the divider 130 is fully engaged with the container 106 and the food placement element 114. Additionally, in some embodiments such as shown in FIGS. 3, 4, and 9, the surface 116 of the food placement element 114 may include a groove 136 for receipt of and/or engagement with a base 138 of the divider 130. When the divider 130 is in a fully engaged position (i.e., fully engaged with the container 106 and the food placement element 114), the base 138 may be disposed within the groove 136 of the food placement element 114 and/or in contact with the portion of the surface 116 defining the groove 136.

Referring to FIGS. 3 and 7, when the divider 130 is uncoupled from the container 106 and the food placement element 114, the air fryer 100 has a single cooking zone or area within the chamber 108. Referring to FIGS. 8 and 9, when the divider 130 is coupled to the container 106 and the food placement element 114 (e.g., is in its fully engaged position), the divider 130 may divide or separate the chamber 108 and/or the single cooking zone into two cooking zones or areas, which may be referred to as dual cooking zones or areas. As mentioned, the air fryer 100 may be configured to operate in a single cooking zone mode and in a dual cooking zone mode. In the single cooking zone mode, the air fryer 100 may cook food for the single cooking zone, that is, with the intention that the divider 130 is not present in the container 106. In the dual cooking zone mode, the air fryer 100 may cook food for the two cooking zones, that is, with the intention that the divider 130 is present in the container 106. As previously described, the air fryer 100 may cook the two cooking zones according to the same or different cooking settings (e.g., time duration and temperature).

Referring to FIGS. 5, 6, 7, and 9, the floor 118 may include a rib 140. As previously described, the food placement element 114 may rest on shoulders 126 of the inner surface, such that there is a space 128 between the floor 118 and the food placement element 114. The space 128 itself may be separated or divided into, or otherwise include, two spaces, including a first space 128a and a second space 128b. The first space 128a may be part of, or otherwise directly below, the first cooking zone, and the second space 128b may be part of, or otherwise directly below, the second cooking zone. The rib 140 functions or operates to impede, limit, and/or restrict air flow and/or heat transfer underneath the food placement element 114 across or between the two spaces 128a, 128b. This, in turn, further isolates the two cooking zones from each other beyond the isolation provided by the divider 130, further enhancing the ability of the air fryer 100 to simultaneously cook food in the two cooking zones independent from each other. That is, because the food placement element 114 extends across or over the two cooking zones, the food placement element 114, such as its groove 138, may impede or prevent the base 138 of the divider 130 from reaching or coming into contact with the floor 118. Without the rib 140, air may flow, and heat may transfer, uninhibitedly between the two spaces 128a, 128b, and in turn, between the two cooking zones. With the rib 140, air flow and heat transfer are prevented, in turn, further isolating the two cooking zones from each other for enhanced dual zone cooking. In some embodiments, the rib 140 may provide about a 5-10% improvement (reduction) in heat transfer compared to if the rib 140 was not present and the floor 118 was flat over that part, although other percent improvements in heat transfer for other embodiments may be possible.

Additionally, as best shown in FIGS. 7 and 9, the food placement element 114 extends over and/or across the rib 140. Other air fryer configurations may utilize two food placement elements (or trays) that are physically separated from each other by a permanent wall extending from the floor on which a divider is positioned. Correspondingly, the surfaces areas of each of the two trays for such other configurations are much smaller (e.g., less than 50%) of a total area of an opening of the air fryer's chamber. When operating without the divider, the wall is still present, restricting air flow between two cooking areas separated by the wall. This may be less than optimal for air frying since air frying is dependent on air flow. In contrast, the air fryer 100 shown in FIGS. 1-9 uses a food placement element 114 with a surface 116 having a surface area that is much greater than 50% of a total cross-sectional area of the chamber 108 (such as corresponding to and/or defined by the area of the opening of the chamber 108), such as at least 90% of the total cross-sectional area. This, in turn, allows the air fryer 100, when operating with a single cooking zone (i.e., without the divider 130), to optimally utilize the entirety of the chamber 108 without being impeded or inhibited by a dividing wall. Accordingly, when operating in the single zone cooking mode (i.e., the divider 130 is not present), a relatively large piece of food (e.g., a whole chicken), such as larger than one of the dual cooking zones and/or that otherwise extends in both of the dual cooking zones, may be placed in the container 106 on a single, flat surface without being impeded by a dividing wall. In addition or alternatively, in the single zone cooking mode, air may optimally flow throughout the entirety of the chamber 108 above the food placement element 114, without being impeded by a dividing wall, which may provide enhanced air frying compared to if a wall restricting air flow is present. At the same time, the rib 140 below the food placement element 140 may restrict air flow and heat transfer below the food placement element 114 for optimal performance when operating in the dual cooking zone mode, as previously described. Accordingly, configuring a rib 140 on the floor 118 while utilizing a food placement element 114 that extends over the rib 140 and that has a surface 116 extending substantially the entirety of the cross-sectional area of the chamber 108 may provide optimal operation for both the single and dual zone cooking modes.

Referring to FIG. 8, the container 106 (such as via its tracks 132) and/or the food placement element 114 (such as via its groove 136) may geometrically define a dividing line dividing or that is between the two cooking zones. The divider 130, when coupled to the container 106, may generally extend along with dividing line, as shown in FIG. 8. Herein, dimensions of the container 106 and/or the chamber 108 may be defined relative to the dividing line. In particular, a width W of the container 106 and/or the chamber 108 may be a dimension that extends parallel with the dividing line, and a length L of the container 106 and/or the chamber 108 may be a dimension that extends perpendicular to the dividing line. Each of the length L and width W dimensions may extend parallel with the floor 118. Also, a height H of the container 106 and/or the chamber 108 may extend perpendicular to each of the length L and width W, as indicated in FIG. 8.

The rib 140 may also have width, length, and height. For at least some embodiments, such as shown in FIGS. 5 and 6, the rib 140 may extend length-wise parallel with the width of the container 106 and/or chamber 108, and may extend width-wise parallel with the length of the container 106 and/or chamber 108. Also, the height of the rib may extend parallel with the height of the container 106 and/or chamber 108. In some embodiments, the length of the rib 140 may be at least 50% of the width of the chamber 108. In particular of these embodiments, the length of the rib 140 is at least 75% of the width of the chamber 106. In still particular of these embodiments, the rib 140 may extend along its length from one side surface to a second, opposing side surface. For example, FIGS. 5 and 6 show the rib 140 extending length-wise from portions of the curved transition surface 124 transitioning the floor 118 to the first pair of side surfaces 120a, 120b. In addition or alternatively, in some embodiments, a width of the rib 140 may be less than 10% of the length of the chamber 108. In particular of these embodiments, the width of the rib 140 is less than 5% of the length of the chamber 108. In addition or alternatively, in some embodiments, a height of the rib 140 is less than 25% of the height of the chamber 108. In particular of these embodiments, the height of the rib 140 is less than 15% of the height of the chamber 108. In addition or alternatively, in some embodiments, a top of the rib 140 contacts a bottom surface 142 of the food placement element 114. In addition or alternatively, in some embodiments, a smallest distance between the rib 140 and the bottom surface 142 of the food placement element 114 is smaller than the height of the rib 140.

In addition, as shown in FIG. 9, when the divider 130 is coupled to the container 106 and the food placement element 114, the food placement element 114 is positioned between the divider 130 and the rib 140. Also, in at least some embodiments, when the divider 130 is coupled to the container 106, the divider 130 and the rib 140 are generally aligned with each other along the length of the rib 140. That is, geometrically, the rib 140 generally extends along its length parallel with the dividing line, and the divider 130 and the rib 140 extend in a geometric plane perpendicular to the floor 118 and/or the surface 116 of the food placement element 114. In other embodiments, the rib 140 may be offset from the divider 130 such that they reside or intersect different geometric planes perpendicular to the floor 118. Also, in the embodiments in FIGS. 5 and 6, the rib 140 is a single, continuous elongate structure. In other embodiments, the rib 140 may include multiple discontinuous portions, including multiple rib portions separated from each other along a length of the container 106, and/or multiple rib portions separated from each other but in alignment with each other along their lengths. Various ways of configuring a rib as a single element or multiple elements below the food placement element 114 in order to restrict air flow and/or heat transfer below the food placement element 114 may be possible.

Referring to FIG. 10, in some embodiments, the air fryer 100 may include a sensor 144 configured to sense a presence or an absence of the divider 130 in the container 106. That is, when the divider 130 is coupled to the container 106, the sensor 144 may detect a presence of the divider 130, and when the divider 130 is uncoupled with the container 106, the sensor 144 may detect an absence of the divider. As mentioned, the air fryer 100 may be configured to operate in a single cooking zone mode and a dual cooking zone mode. In addition, when operating in the dual cooking zone mode, the air fryer 100 may be configured to cook in the two cooking zones according to the same cooking setting, or with different or independent cooking settings. The sensor 144 may facilitate the operation of the air fryer 100 in the different cooking zone modes by detecting the presence or absence of the divider 130. That is, if the sensor 144 detects an absence of the divider 130, then the control panel 104, which may be operatively coupled to the sensor 144, may determine that the air fryer 100 is to operate in the single cooking zone mode. In addition, if the sensor 144 detects a presence of the divider 130, then the control panel 104 may determine that the air fryer 100 is to operate in the dual cooking zone mode. Determination of which type of zone cooking mode the air fryer 100 is in may, in turn, facilitate further operation of the air fryer 100 and/or the options, settings, and/or selections that the control panel 102 displays or presents to a user. For example, the air fryer 102 may have a first set of cooking settings or options for user selection specific to the single cooking zone mode, and a second set of cooking settings or options for selection specific to the dual cooking zone mode. The air fryer 100, via the control panel 104, may present the first set or the second set to the user based on the sensing performed by the sensor 144 without having to wait or be dependent on the user inputting to control panel 104 which cooking zone mode in which the user wants the air fryer 100 to operate.

Additionally, the sensor 144 may be of any suitable type capable of detecting a presence or absence of the divider 130, such as a switch, a force sensor, a contact sensor, an infrared (IR) sensor, or a motion sensor, as non-limiting examples. In addition or alternatively, the sensor 144 may be configured in any of various ways in order to detect the presence or absence of the divider 130. For example, the sensor 144 may be mounted to the inner surface, such as to a side surface 120, of the container 106. As another example, the sensor 144 may be mounted within the housing 102 but external to the container 106. The container 106 may include a cutout or hole that provides access for the sensor 144 to within the chamber 108 in order to detect the presence or absence of the divider 130.

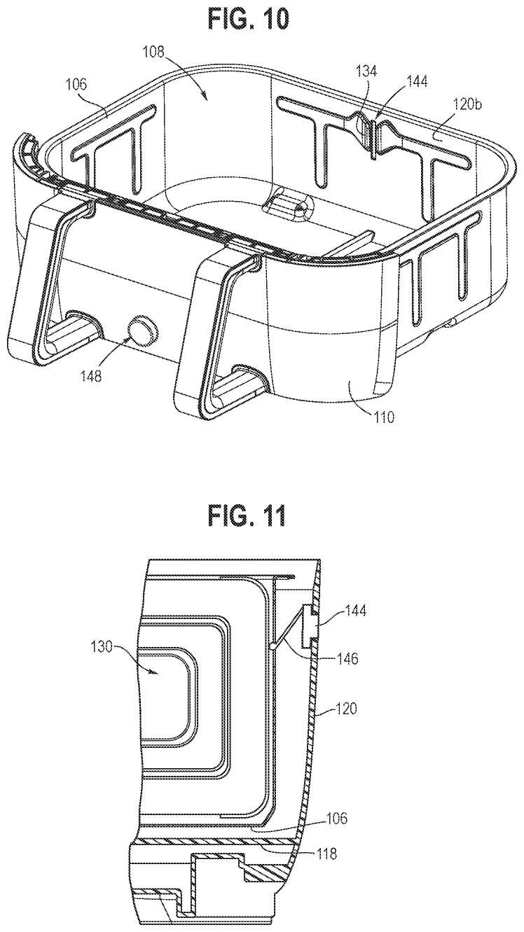

Referring to FIG. 11, in some embodiments, the sensor 144, such as in the form of a switch, may be coupled to an actuator arm 146 extending into the chamber 108. The actuator arm 146 may extend a sufficient amount into the chamber 108 and be positioned relative to one of the track 132 so as to make contact with the divider 130 when the divider 130 couples to the container 108. Correspondingly, the actuator arm 146 may be movable between a first position and the second position. The actuator arm 146 is in the first position when the divider 130 is not coupled to the container 106 or when the actuator arm is otherwise not in contact with the divider 130. In addition, the actuator arm 146 is in the second position when the divider 130 is coupled to the container 106 and/or is in contact with the divider 130. The sensor 144, coupled to the actuator arm 146, may detect whether the actuator arm 146 is in the first position or in the second position. Accordingly, when the actuator arm 146 is in the first position, the sensor 144 senses or detects that the divider 130 is coupled to or engaged with the container 106, and in turn, senses that the air fryer 100 is configured for the dual cooking zone mode. In addition, when the actuator arm 146 is in the second position, the sensor 144 senses or detects that the divider 130 is uncoupled with or disengaged from the container 106, and in turn, senses that the air fryer 100 is configured for the single cooking zone mode.

Referring back to FIG. 10, in some embodiments, the air fryer 100 may include an ejection or release button 148 configured to eject the divider 130 out of its fully engaged or coupled position within the container 106. As mentioned, the divider 130 may be fully engaged or coupled to the container 106 and the food placement element 114 when the base 138 of the divider 130 is in or engaged with the groove 136 of the food placement element 114, is in contact with the food placement element 114, or is otherwise at a lower-most position within the container 106. In addition or alternatively, when the divider 130 is in its fully engaged position, the divider 130 may form an interference or friction fit with the container 106. For example, the divider 130 may include bumpers 150 made of silicon, rubber, or other similar material that engages with the side surfaces 120a, 120b of the container 106. The bumpers 150 may desirably form a seal with the side surfaces 120a, 120b to enhance isolation between the cooking zones. Additionally, the bumpers 150 may prevent or reduce damage, scratching, or general wear and tear to the side surfaces 120a, 120b of the container 106 caused by the slidable engagement of the divider 130, and/or may help to secure or stabilize the divider 130 in its perpendicular or upright position within the container 106. However, the interference fit created by the bumpers 150 may, in turn, make it difficult for a user to remove or uncouple the divider 130 from the container 106. The ejection button 148 may eject or pop the divider 130 out of its fully engaged position, which may have the effect of removing or at least decreasing the interference fit between the divider 130 and the container 106, and/or may raise an upper edge 152 of the divider 130 higher than the upper edge 117 of the container. After the divider 130 is ejected from its fully engaged position, removal of the divider 130 from within the container 106 is easier for the user.

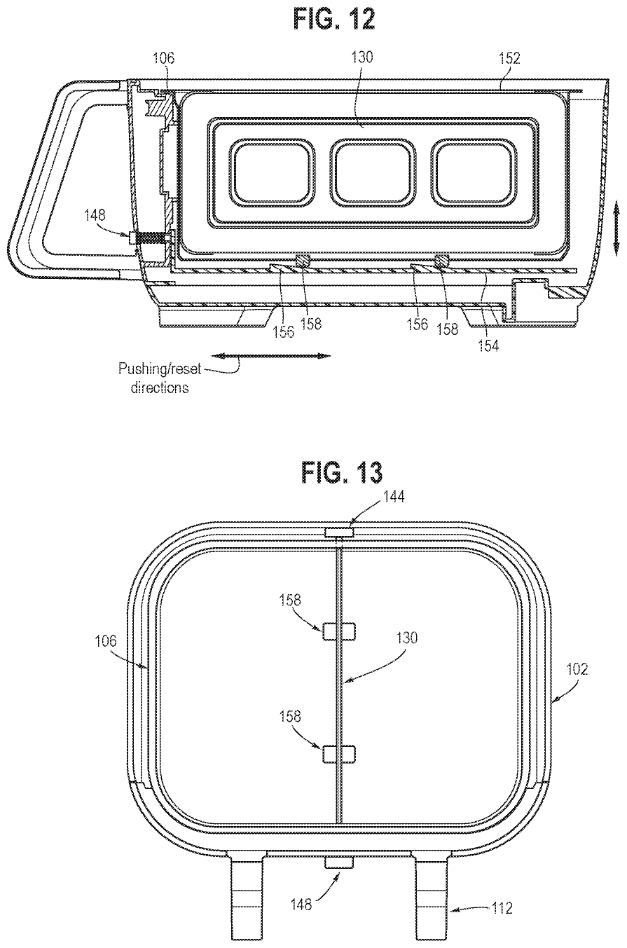

Referring to FIGS. 12 and 13, in some embodiments, the ejection button 148 may be a push button operatively connected to the divider 130 via a mechanical connection. To eject the divider 130, the push button 148 is pushed in a pushing direction that moves or ejects the divider 130 out of its fully engaged position. In addition, the push button 148 may move in an opposing, reset direction so that the push button 148 can once again be pushed by a user to eject the divider 130 from its fully engaged position. In at least some embodiments, the push button 148 is spring loadable in order to facilitate operation of the push button 148 in its push and reset direction.

The mechanical connection forming the operative connection between the push button 148 and the divider 130 may include a slide actuator 154 configured to move or slide corresponding to the pushing and reset directions of the push button 148. The slide actuator 154 may include one or more ramp portions 156 coupled to movable ejector pins or tabs 158 that project or extend through the floor 118 into the chamber 108 to make contact with the bottom surface 142 of the food placement element 114. The more the slide actuator 154 moves in the push direction, the more the ramped portions 156 move the pins 158 into the chamber 108, causing the pins 158 to push on the food placement element 114 to, in turn, causing the food placement element 114 to eject the divider 130 from its fully engaged position. Additionally, the push button 148 moving in the reset direction may cause the slide actuator 154 to move in the reset direction, in turn causing the ramped portions 156 to lower the pins 158 back to initial positions.

Any of various embodiments of the air fryer 100 may include some, all, or fewer than all of the features described herein. For example, any of various embodiments of the air fryer 100 described herein may include at least one, including any of various combinations, of the following features: the rib 140, detection of a presence or absence of the divider 130 (such as by having the sensor 144), and/or ejection of the divider 130 from its fully engaged position (such as by having the ejection button 148 and corresponding ejection assembly.

The subject matter of the present description may also relate, among others, to the following aspects:

A first aspect includes an apparatus comprising: a housing; a chamber within the housing in which food to be air fried is disposed; a food placement element comprising a surface on which the food is placed in the chamber; and a container in which the food placement element is disposed within the housing, wherein the container comprises a floor comprising a rib, and wherein the food placement element extends over the rib.

A second aspect includes the first aspect, and further includes wherein the floor has a width extending parallel with a dividing line between a first cooking zone and a second cooking zone, wherein the rib has a length at least 50 percent of the width of the chamber.

A third aspect includes the second aspect, and further includes wherein the length of the rib is at least 75 percent of the length of the width of the chamber.

A fourth aspect includes the third aspect, and further includes wherein the rib extends lengthwise from a first side surface of the container to a second side surface of the container, the second side surface opposing the first side surface.

A fifth aspect includes any of the first through fourth aspects, and further includes wherein the floor has a length extending perpendicular to a dividing line between a first cooking zone and a second cooking zone, wherein the rib has a width less than 10 percent of the length of the chamber.

A sixth aspect includes the fifth aspect, and further includes wherein the width of the rib is less than 5 percent of the length of the chamber.

A seventh aspect includes any of the first through sixth aspects, and further includes wherein a height of the rib is less than 25 percent of a height of the chamber.

An eighth aspect includes the seventh aspect, and further includes wherein the height of the rib is less than 15 percent of the height of the chamber.

A ninth aspect includes any of the first through eighth aspects, and further includes wherein the food placement element comprises an only food placement element of the apparatus.

A tenth aspect includes any of the first through ninth aspects, wherein a surface area of the food placement element is at least 90 percent of an area of an opening of the chamber.

An eleventh aspect includes any of the first through tenth aspects, and further includes a divider configured for removable coupling with the container, the divider, when coupled to the container, dividing the chamber into a first cooking zone and a second cooking zone, wherein the food placement element is positioned between the rib and the divider.

A twelfth aspect includes the eleventh aspect, and further includes wherein the chamber defines a single cooking zone when the divider is uncoupled from the container.

A thirteenth aspect includes any of the eleventh or twelfth aspects, and further includes wherein the surface of the food placement element comprises a groove, wherein a base of the divider is positioned in the groove when the divider is fully coupled to the container.

A fourteenth aspect includes any of the eleventh through thirteenth aspects, and further includes a sensor configured to detect a presence or an absence of the divider in the chamber.

A fifteenth aspect includes the fourteenth aspect, and further includes an actuator arm projecting into the chamber and operatively coupled to the sensor, the actuator arm movable between a first position and a second position, the actual arm in the first position when the divider is not in the chamber and in the second position when in the chamber, and the sensor detecting the presence or absence in response to whether the actuator arm is in the first position or in the second position.

A sixteenth aspect includes any of the eleventh through fifteenth aspects, and further includes an ejection button configured to eject the divider from a fully engaged position.

A seventeenth aspect includes the sixteenth aspect, and further includes wherein the ejection button comprises a push button.

An eighteenth aspect includes the seventeenth aspect, and further includes a slide actuator operatively coupled to the ejection button, the slide actuator configured to push the divider out of the fully engaged position.

A nineteenth aspect includes the eighteenth aspect, and further includes wherein the slide actuator comprises at least one ramp portion configured to increase an amount one or more ejector tabs biasing the divider move into the chamber to eject the divider from the fully engaged position.

A twentieth aspect includes an apparatus comprising: a housing; a container defining a chamber in which food to be air fried is disposed; a divider removably disposed within the container, the divider dividing the chamber into a first cooking zone and a second cooking zone; and a sensor configured to sense a presence or an absence of the divider within the chamber.

A twenty-first aspect includes an apparatus comprising: a housing; a container defining a chamber in which food to be air fried is disposed; a divider removably disposed within the container, the divider dividing the chamber into a first cooking zone and a second cooking zone; and an ejection button configured to eject the divider from a fully coupled position within the container.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An apparatus comprising:
a housing;
a chamber within the housing in which food to be air fried is disposed;
a food placement element comprising a surface on which the food is placed in the chamber; and
a container in which the food placement element is disposed within the housing,
wherein the container comprises a floor comprising a rib, and
wherein the food placement element extends over the rib.

2. The apparatus of claim 1, wherein the floor has a width extending parallel with a dividing line between a first cooking zone and a second cooking zone, wherein the rib has a length at least 50 percent of the width of the chamber.

3. The apparatus of claim 2, wherein the length of the rib is at least 75 percent of the length of the width of the chamber.

4. The apparatus of claim 3, wherein the rib extends lengthwise from a first side surface of the container to a second side surface of the container, the second side surface opposing the first side surface.

5. The apparatus of claim 1, wherein the floor has a length extending perpendicular to a dividing line between a first cooking zone and a second cooking zone, wherein the rib has a width less than 10 percent of the length of the chamber.

6. The apparatus of claim 5, wherein the width of the rib is less than 5 percent of the length of the chamber.

7. The apparatus of claim 1, wherein a height of the rib is less than 25 percent of a height of the chamber.

8. The apparatus of claim 7, wherein the height of the rib is less than 15 percent of the height of the chamber.

9. The apparatus of claim 1, wherein the food placement element comprises an only food placement element of the apparatus.

10. The apparatus of claim 1, wherein a surface area of the food placement element is at least 90 percent of an area of an opening of the chamber.

11. The apparatus of claim 1, further comprising a divider configured for removable coupling with the container, the divider, when coupled to the container, dividing the chamber into a first cooking zone and a second cooking zone, wherein the food placement element is positioned between the rib and the divider.

12. The apparatus of claim 11, wherein the chamber defines a single cooking zone when the divider is uncoupled from the container.

13. The apparatus of claim 11, wherein the surface of the food placement element comprises a groove, wherein a base of the divider is positioned in the groove when the divider is fully coupled to the container.

14. The apparatus of claim 11, further comprising a sensor configured to detect a presence or an absence of the divider in the chamber.

15. The apparatus of claim 14, further comprising an actuator arm projecting into the chamber and operatively coupled to the sensor, the actuator arm movable between a first position and a second position, the actual arm in the first position when the divider is not in the chamber and in the second position when in the chamber, and the sensor detecting the presence or absence in response to whether the actuator arm is in the first position or in the second position.

16. The apparatus of claim 11, further comprising an ejection button configured to eject the divider from a fully engaged position.

17. The apparatus of claim 16, wherein the ejection button comprises a push button.

18. The apparatus of claim 17, further comprising a slide actuator operatively coupled to the ejection button, the slide actuator configured to push the divider out of the fully engaged position.

19. The apparatus of claim 18, wherein the slide actuator comprises at least one ramp portion configured to increase an amount one or more ejector tabs biasing the divider move into the chamber to eject the divider from the fully engaged position.

20. An apparatus comprising:
a housing;
a container defining a chamber in which food to be air fried is disposed;
a divider removably disposed within the container, the divider dividing the chamber into a first cooking zone and a second cooking zone; and
a sensor configured to sense a presence or an absence of the divider within the chamber.

21. An apparatus comprising:
a housing;
a container defining a chamber in which food to be air fried is disposed;
a divider removably disposed within the container, the divider dividing the chamber into a first cooking zone and a second cooking zone; and
an ejection button configured to eject the divider from a fully coupled position within the container.
